(19) United States
(12) Patent Application Publication
(10) Pub. No.: US 2026/0165249 A1
(43) Pub. Date: Jun. 18, 2026

(54) HARVESTING ATTACHMENT FOR WHOLE PLANT HARVESTING

(71) Applicant: DEERE & COMPANY, MOLINE, IL (US)

(72) Inventors: Maximilian Schroeder, Emsdetten (DE); Richard Wuebbels, Borken (DE); Dirk Bongert, Gesher (DE); Ralf Leveling, Gronau (DE); Frank Schlamann, Gronau (DE)

(21) Appl. No.: 19/363,740

(22) Filed: Oct. 21, 2025

(30) Foreign Application Priority Data
Dec. 16, 2024 (EP) 24220261.2
Dec. 21, 2024 (EP) 24222685.0

(51) Int. Cl. A01D 57/20; A01D 41/14; A01D 61/00; A01D 61/02

(52) U.S. Cl. CPC A01D 57/20; A01D 41/14; A01D 61/004; A01D 61/02

(57) ABSTRACT

A harvesting attachment for whole plant harvesting, attachable to a harvesting machine and movable over a field in a forward direction, is provided. The harvesting attachment includes a supporting framework, mowing and intake devices for cutting and conveying plants from the field, a first and transverse conveyor belts for conveying the plants picked up by the mowing and intake devices transversely in the direction of the longitudinal central plane of the harvesting attachment, a discharge conveyor belt for conveying the plants coming in from the transverse conveyor belts rearward to a rear discharge point of the harvesting attachment, and an elongate conveyor drum operable in an undershot manner and having an axis of rotation extending transversely to the forward direction. The conveyor drum is connected to the framework above the discharge conveyor belt, in front of the discharge opening, by a support provided in the center of the conveyor drum.

### CROSS-REFERENCE TO RELATED APPLICATIONS

This application claims priority to European Patent Application No. 24220261.2, filed Dec. 16, 2024, and European Patent Application No. 24222685.0, filed Dec. 21, 2024, both of which are hereby incorporated by reference.

### TECHNICAL FIELD

The present disclosure relates to a harvesting attachment for whole plant harvesting, which can be attached to a harvesting machine and can be moved over a field in a forward direction.

### BACKGROUND

Among the devices used in the prior art for harvesting complete stalk-type plants, such as cereals or grass, are harvesting attachments with transverse conveyor belts (referred to as “raper belts”). For harvesting cereals, there are known headers which hold the plants or convey them backward by means of a reel and cut them off with mowing knives. The cut, above-ground parts of the plants come to lie on the transverse conveyor belts and are transported by these to the center of the harvesting attachment. There they are taken over by a central conveyor belt, which conveys them away to the rear and discharges them through a rear opening into a feeder house. The feeder house conveys the plants into a self-propelled harvesting machine, usually a combine harvester.

Harvesting attachments with transverse conveyor belts are also used in conjunction with forage harvesters for harvesting green material (grass or other relatively short stalk-type plants, such as cereals for whole plant silage) by means of a pick-up drum or a drum or disk mower (EP 1 256 272 A1, EP 3 058 802 A1) or lower cutting disks and conveying rotors arranged coaxially thereabove (DE 10 2015 206 845 A1 for harvesting plants smaller than corn). EP 4 356 713 A1 furthermore shows a harvesting attachment provided for corn harvesting, having transverse conveyor belts, in front of which mowing and intake devices with lower cutting disks and in each case a plurality of conveying rotors arranged coaxially thereabove are arranged.

On harvesting attachments with transverse conveyor belts, conveyor drums fitted with fingers, feed screws or rigid drivers are often arranged above the discharge opening, and convey the crop rearward. These conveyor drums are supported at both ends on the supporting framework of the harvesting attachment, wherein the axis of rotation can be offset rearward relative to the rear wall (EP 2 772 130 A1) or can be located in front of it, such that the conveyor drum is secured by suspension mounts on the framework, which extend forward from the rear wall (U.S. 2008/0295474 A1). In the first case, the conveyor drum serves essentially only to pull the crop in toward the rear, while, in the second case, it can also to a certain extent catch crop coming in from the outside, i.e. from the transverse conveyor belts. Here, however, the lateral suspension mounts have proven problematic when harvesting relatively large plants such as corn since they lead to a buildup on the mounts of plants coming in from the side.

In the case of previous harvesting attachments for corn, on which transverse conveyance is accomplished by the rear sides of the mowing and intake devices and, where applicable, by transverse conveyor drums and deflection rearward toward the harvesting machine by discharge conveyor drums, there is in some cases the problem that plants are not caught by the discharge conveyor drums as they are deflected rearward in the center of the harvesting attachment, and therefore these plants are left lying crosswise in front of the discharge conveyor drums. To push these plants downward and rearward, there has been a proposal for a deflecting element which is situated in front of and above the transverse conveying duct of the harvesting attachment and the intake duct of the harvesting machine (DE 101 08 516 A1). The deflecting element can be embodied as a centrally supported roll of triangular cross section rotating about the transverse axis and serves to push any crop that accumulates in front of the discharge conveyor drums downward or rearward.

### SUMMARY

A harvesting attachment for whole plant harvesting is provided. The harvesting attachment for whole plant harvesting can be attached to a harvesting machine and can be moved over a field in a forward direction. The harvesting attachment may include a supporting framework, a number of juxtaposed mowing and intake devices for cutting and conveying plants from the field, a first transverse conveyor belt and a second transverse conveyor belt for conveying the plants picked up by the mowing and intake devices transversely in the direction of the longitudinal central plane of the harvesting attachment, a discharge conveyor belt for conveying the plants coming in from the transverse conveyor belts rearward to a rear discharge point of the harvesting attachment, and an elongate conveyor drum which operates in an undershot manner and has an axis of rotation extending transversely to the forward direction. The conveyor drum is connected to the framework above the discharge conveyor belt, in front of the discharge opening, by a support provided only in the center of the conveyor drum.

In this way, it is ensured that the crop coming in from the outside via the transverse conveyor belts does not build up or is at least less likely to build up on the support of the conveyor drum.

Other features and aspects will become apparent by consideration of the detailed description and accompanying drawings.

### BRIEF DESCRIPTION OF THE DRAWINGS

FIG. 1 is a schematic side view of a harvesting machine with a harvesting attachment for whole plant harvesting,

FIG. 2 is a perspective view of the harvesting attachment from FIG. 1 from the left-hand side and obliquely from the front,

FIG. 3 is an enlarged, perspective view of a conveyor drum of the harvesting attachment, and

FIG. 4 is a perspective view of the conveyor drum with the roll shells removed.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

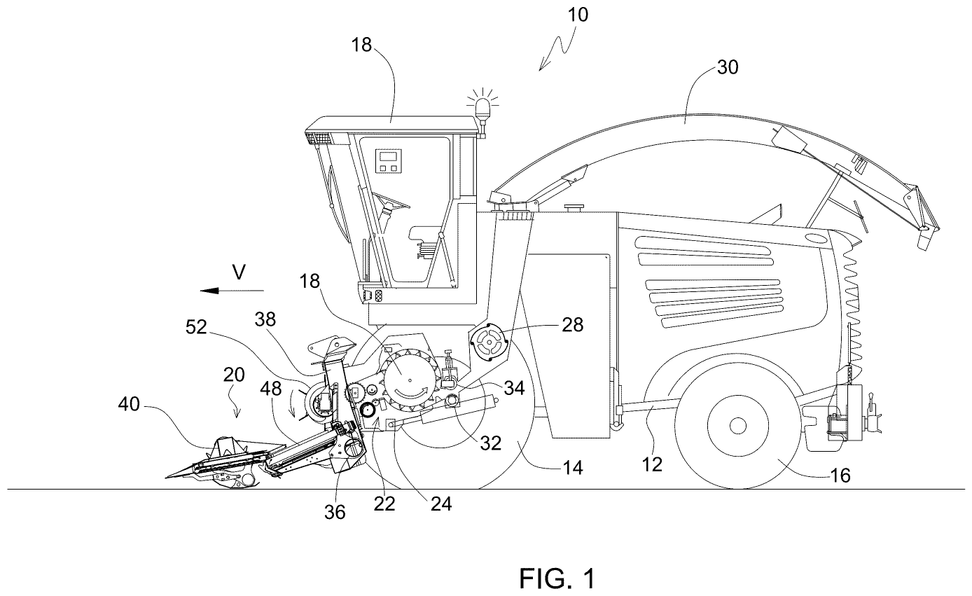

A harvesting machine in the form of a self-propelled forage harvester 10 is illustrated in a schematic side view in FIG. 1. The forage harvester 10 is built on a frame 12 which is supported by driven front wheels 14 and steerable rear wheels 16. The forage harvester 10 is operated from a driver's cab 18, from which a harvesting attachment 20 for whole plant harvesting is visible. Crop, for example corn or other stalk-type plants, picked up from the ground by the harvesting attachment 20, is fed via an intake conveyor 22 having precompression rollers, which are arranged within an intake housing 24 on the front side of the forage harvester 10, to a chopper drum 26, which is arranged below the driver's cab 18, chops it into small pieces in cooperation with a counter cutter and, after it has run through a post-processing device having two processor rollers 32, 34, discharges it onto a conveying device 28. The crop exits the harvesting machine 10 to a transporter, traveling alongside, via a discharge chute 30 that is rotatable about an approximately vertical axis and is adjustable in inclination. In the following text, direction indications, such as sideways, downward and upward, relate to the forward direction V of the forage harvester 10, which runs to the left in FIG. 1.

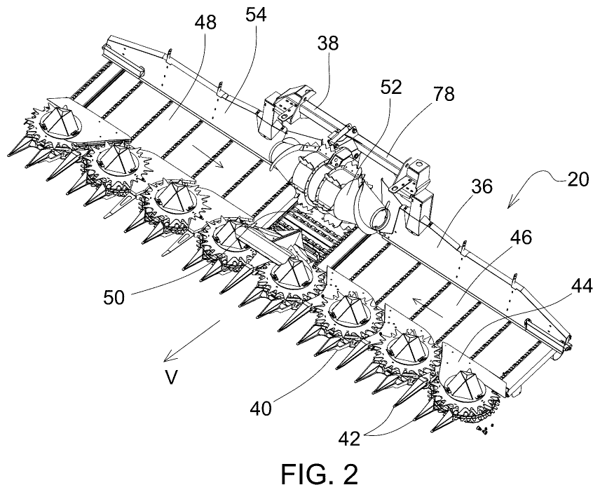

FIG. 2 shows a perspective view of the harvesting attachment 20 suitable for whole plant harvesting. The harvesting attachment 20 is built on a supporting framework 36, which is provided in the center with a rear mounting frame 38. The mounting frame 38 is used to attach the harvesting attachment 20 to the intake housing 24 of the forage harvester 10. As a discharge point for the harvested plants, the mounting frame 38 has a central discharge opening, through which harvested crops picked up from a field can be discharged into the intake conveyor 22.

On its front side, the supporting framework 36 holds a number (eight in the exemplary embodiment illustrated) of mowing and intake devices 40 of the kind used on conventional harvesting attachments for harvesting relatively large stalk-type plants (especially corn). The mowing and intake devices 40 comprise (cf. EP 0 760 200 A1), lower cutting disks (rotating or stationary) and conveying disks arranged thereabove with recesses distributed around their circumference for receiving plants that are cut off by the cutting disks from their roots, which remain in the ground. Stalk dividers 42 are arranged in front of the mowing and intake devices 40. During harvesting, the mowing and intake devices 40 (apart from the outer mowing and intake devices 40 operating in the opposite direction thereto) convey the plants initially outward laterally on their front sides, then rearward and finally inward by their rear sides and discharge the plants to the outside in a manner offset relative to the axis of rotation of the mowing and intake devices 40 since the plants are pushed rearward and inward there out of the recesses of the conveying disks of the mowing and intake devices 40 by strippers 44 that penetrate into the enveloping circle of the conveying disks of the mowing and intake devices 40. Accordingly, the plants are discharged rearward and inward and, being pushed rearward by subsequent plants coming in from the front, get onto a transverse conveyor belt 46 or 48, which moves inward, in the direction of the longitudinal central plane of the harvesting attachment 20 during harvesting. In the center of the harvesting attachment 20, the crop is taken over by a discharge conveyor belt 50, which brings the crop coming in from the transverse conveyor belts 46 and 48 rearward through the discharge opening of the mounting frame 38 and into the intake conveyor 22. The two central mowing and intake devices 40 directly adjacent to the longitudinal central plane of the harvesting attachment 20 discharge their crop directly onto the discharge conveyor 50. Rear walls 54 are provided to the rear of the transverse conveyor belts 46, 48. In the figures, the longitudinal axes (conveying directions) of the transverse conveyor belts 46, 48 extend transversely to the forward direction V. They could also be arranged in a V shape, as in EP 3 298 879 A1.

Since the complete cut plants are conveyed into the harvesting machine, the harvesting attachment 20 thus serves for whole plant harvesting of larger stalk-type plants, such as corn. The mowing and intake devices 40 can also be used (optionally with slight modifications, cf. EP 0 824 856 A2) for introducing what is referred to as whole plant silage, e.g., cereal plants.

Above the discharge conveyor belt 50, upstream of the rear discharge opening and the rear wall 54, an elongate conveyor drum 52 in which the diameter is less than the axial length is provided which facilitates the introduction of the plants into the discharge opening. On each side of the longitudinal central plane, the conveyor drum 52 comprises a shell, which comprises a central, cylindrical part 60 and outer conical regions 56. The conical regions 56 of the conveyor drum 52 are provided with helical drivers 58, while the central, cylindrical part 60 of the conveyor drum 52 is provided with axially extending, toothed drivers 62. The conveyor drum 52 can be driven in the direction of the arrow illustrated in FIG. 1.

The upper sides of the transverse conveyor belts 46, 48, which are arranged horizontally or slightly forwardly and downwardly inclined with respect to the forward direction V, move inward during harvesting, while the upper side of the discharge conveyor belt 50, which is arranged horizontally or slightly rearwardly and upwardly inclined with respect to the forward direction V, then moves rearward, as indicated by the arrows in FIG. 2. The mowing and intake devices 40 as well as the transverse conveyor belts 46, 48 and the discharge conveyor belt 50 and, where applicable, the conveyor drum 52 can be driven via a mechanical drive train from the forage harvester 10 carrying the harvesting attachment 20 or by associated electric or hydraulic motors (not shown), which make it possible to adjust the conveying speed and to adapt it to the conveying speed in the intake conveyor 22 of the forage harvester 10 and thus to the cutting length.

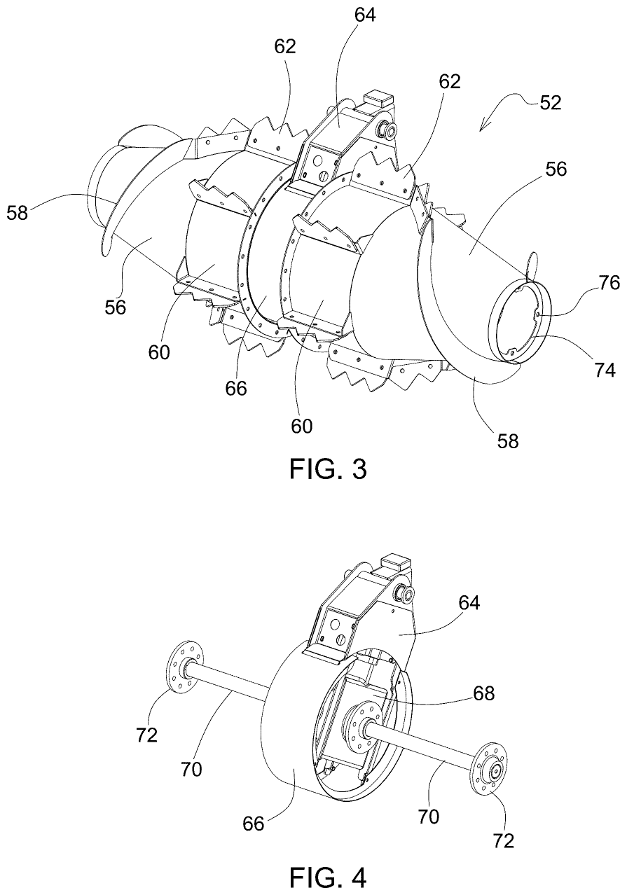

Reference is now made to FIGS. 3 and 4, in which the construction of the conveyor drum 52 and its coupling to the framework 36 of the harvesting attachment 20 are illustrated. The conveyor drum 52, which is symmetrical with respect to the longitudinal central plane of the harvesting attachment 20, is secured on an upper cross strut 78 of the mounting frame 38 by a central rocker 64. The rocker 64 is freely rotatable relative to the cross strut 78 about the transverse axis between lower and upper stops (not shown), which restrict the rotation angle of the rocker 64 about the transverse axis in a fixed or adjustable manner. Accordingly, the conveyor drum 52 can give way upward, depending on the crop throughput, and it compacts the crop by its dead weight.

The rocker 64 is firmly connected to a cylindrical ring 66, which, on the inside, contains at least one of a drive 68 supported on the rocker 64 and on the ring 66. The drive 68 contains a hydraulic or electric motor, which is connected to a pressure or power source located on board the harvesting machine 10 via lines (not shown), which run through the rocker 64 and along or through the cross strut 38. In another embodiment, the lines and the motor could be replaced by a mechanical drivetrain, e.g., a flexible shaft or meshing spur gearwheels, which connects the drive 68 to a drive source.

The drive 68 is connected on both sides to a respective driven output shaft 70, which extends in the transverse direction and supports a flange 72 at its outer end. The conical regions 56 of the conveyor drum 52 are screwed to the flanges 72, for which purpose inner supporting rings 74 with openings 76 to receive the screws, which are screwed into threaded holes in the flanges 72, are provided on the outer end regions of the conical regions 56. The cylindrical parts 60 of the conveyor drum 52 are connected firmly (e.g., by welding or the like) to the conical regions 56 or produced in one piece therewith. The inner ends of the cylindrical parts 60 cover the ring 66 in the axial direction. One or more seals, bearing elements, or both could furthermore be mounted between the inner ends of the cylindrical parts 60 and the ring 66.

It is apparent that the axis of rotation of the conveyor drum 52 is situated in front of the rear wall 54, and its conical regions 56 (also) catch crop coming in from the side, such as from the transverse conveyor belts 46, 48, by the helical drivers 58. In the illustrated example, the support of the conveyor drum 52 on the framework 36, which is provided only in the center of the conveyor drum 52 by the rocker 64, makes it possible for the two halves of the conveyor drum 58 to extend outward with the central parts 60 and the conical regions 56 in a cantilevered manner from the rocker 64. As a result, there are no connections in the form of struts or the like between the outer ends of the conveyor drum 52 and the rear wall 54 or other parts of the supporting framework 36, which would disrupt the crop flow, and the conveyor drum 52 can be positioned in a freestanding manner in front of the rear wall 54. Accordingly, an optimum conveying effect of the conveyor drum 52 is obtained, especially for crop coming in from the outside, without the risk of a crop buildup.

What is claimed is

1. A harvesting attachment for whole plant harvesting configured to be attached to a harvesting machine and movable over a field in a forward direction, the harvesting attachment comprising:
a supporting framework,
a plurality of juxtaposed mowing and intake devices configured to cut and convey plants from the field,
a first transverse conveyor belt;
a second transverse conveyor belt, the first transvers conveyor belt and the second transverse conveyor belt configured to convey the plants picked up by the mowing and intake devices transversely in the direction of a longitudinal central plane of the harvesting attachment,
a discharge conveyor belt configured to convey the plants coming in from the transverse conveyor belts rearward to a rear discharge opening of the harvesting attachment, and
an elongate conveyor drum configured to operate in an undershot manner and including an axis of rotation extending transversely to the forward direction, wherein the conveyor drum is connected to the framework above the discharge conveyor belt, in front of the discharge opening, by a support, and
wherein the support of the conveyor drum on the framework is provided in the center of the conveyor drum.

2. The harvesting attachment of claim 1, further including a rear wall, and wherein the axis of rotation of the conveyor drum is arranged in front of the rear wall.

3. The harvesting attachment of claim 1, wherein the conveyor drum is rotatable by a drive that is powered by a drivetrain.

4. The harvesting attachment of claim 1, wherein the conveyor drum is connected to the framework by a rocker attached rigidly or pivotably to the framework.

5. The harvesting attachment of claim 3, wherein the conveyor drum is connected to the framework by a rocker attached rigidly or pivotably to the framework, wherein the drive is connected to the rocker, wherein the drive is connected on both sides to output shafts, and wherein each of the output shafts is connected to a shell of the conveyor drum.

6. The harvesting attachment of claim 5, wherein each shell of the conveyor drum include a cylindrical part and an outer conical region.

7. The harvesting attachment of claim 6, wherein the conical regions of the conveyor drum include a helical driver.

8. The harvesting attachment of claim 6, wherein the cylindrical parts of the conveyor drum includes a plurality of axially extending drivers.

9. The harvesting attachment of claim 8, wherein each of the plurality of axially extending drivers include teeth.

10. The harvesting attachment of claim 6, wherein the drive includes a ring attached to the rocker.

11. The harvesting attachment of claim 10, wherein an inner end of each of the cylindrical parts covers an axially arranged end portion of the ring.

12. The harvesting attachment of claim 4, further including a mounting frame configured to attach the harvesting attachment to an intake housing of a harvesting machine, wherein the rocker is secured on an upper cross strut of the mounting frame.

13. The harvesting attachment of claim 1, wherein the conveyor drum is arranged symmetrically with respect to the longitudinal central plane of the harvesting attachment.

14. The harvesting attachment of claim 1, wherein each of the mowing and intake devices include a lower cutting disk and a conveying disk arranged thereabove, wherein the conveying disk includes recesses distributed around a circumference of the conveying disk, and wherein the recesses are configured to receive plants that are cut off from roots thereof by the cutting disk.

15. A harvester comprising:
a harvesting attachment for whole plant harvesting configured to be attached to harvester and movable over a field in a forward direction, the harvesting attachment including:
a supporting framework,
a plurality of juxtaposed mowing and intake devices configured to cut and convey plants from the field,
a first transverse conveyor belt;
a second transverse conveyor belt, the first transvers conveyor belt and the second transverse conveyor belt configured to convey the plants picked up by the mowing and intake devices transversely in the direction of a longitudinal central plane of the harvesting attachment,
a discharge conveyor belt configured to convey the plants coming in from the transverse conveyor belts rearward to a rear discharge opening of the harvesting attachment, and
an elongate conveyor drum configured to operate in an undershot manner and including an axis of rotation extending transversely to the forward direction, wherein the conveyor drum is connected to the framework above the discharge conveyor belt, in front of the discharge opening, by a support, and
wherein the support of the conveyor drum on the framework is provided in the center of the conveyor drum.

16. The harvesting of claim 15, wherein the attachment further includes a rear wall, and wherein the axis of rotation of the conveyor drum is arranged in front of the rear wall.

17. The harvester of claim 15, wherein the conveyor drum is rotatable by a drive that is powered by a drivetrain.

18. The harvester claim 15, wherein the conveyor drum is connected to the framework by a rocker attached rigidly or pivotably to the framework.

19. The harvester of claim 17, wherein the conveyor drum is connected to the framework by a rocker attached rigidly or pivotably to the framework, wherein the drive is connected to the rocker, wherein the drive is connected on both sides to output shafts, and wherein each of the output shafts is connected to a shell of the conveyor drum.

20. The harvester of claim 19, wherein each shell of the conveyor drum include a cylindrical part and an outer conical region.
